(19) United States
(12) Patent Application Publication
(10) Pub. No.: US 2003/0044680 A1
(43) Pub. Date: Mar. 6, 2003

(54) Polymer materials for use in an electrode

(75) Inventor: Teruo Umemoto, Westminster, CO (US)

Correspondence Address: MERCHANT & GOULD PC, P.O. BOX 2903, MINNEAPOLIS, MN, 55402-0903, US

(73) Assignee: IM&T Research, Inc.

(21) Appl. No.: 09/939,345

(22) Filed: Aug. 24, 2001

(51) Int. Cl. H01M 4/60; H01M 4/86; H01G 9/042

(52) U.S. Cl. 429/213; 429/43; 361/516; 361/532

(57) ABSTRACT

A carbonyl aromatic polymer electrode material, suitable for use as both positive and negative electrodes in electric storage devices, is disclosed. The polymers contain at least one unit having at least one cyclopentanone structure condensed with at least two aromatic rings. Exemplary carbonyl aromatic polymers include polymers containing units of 9-fluorenone, cyclopenta[def]fluorene-4,8-dione, and benzo[b]fluoren-11-one. The carbonyl structure in the polymers make them very effective electrode materials which can also be anion or cation doped to increase their performance further. In addition, the polymers are proton or hydroxide anion mediators which makes them also suitable for use in electrodes in fuel cells.

### RELATED APPLICATION

The disclosure is related to the co-pending application entitled “Method for Preparing Polymers Containing Cyclopentanone Structures,” filed on the same day as the present invention and assigned to the assignee of the present invention, and is herein incorporated by reference.

### FIELD OF THE INVENTION

The disclosure relates generally to electrode materials and to electric energy-generating or -storing devices produced using the electrode materials, and more particularly to polymers having at least one unit of at least one cyclopentanone structure condensed with at least two aromatic rings, for example, poly(9-fluorenone) or its derivatives, as an electrode material for use in electric energy-generating or -storing devices, i.e., batteries, capacitors and/or fuel cells.

### BACKGROUND OF THE INVENTION

Electric energy-generating or -storing devices, e.g., batteries, capacitors, and fuel cells play a critical role within industrialized society. For example, batteries power numerous devices such as cameras, personal computers, MP3 players, cellular phones, electric vehicles, and are required for electric energy storage in large scale load leveling. The economic and environmental impact of this usage is staggering and represents a major point of interest for those in and outside the art.

A battery, in general, is an electrochemical device that generates electric current by converting chemical energy to electrical energy via oxidation-reduction reactions. Batteries can be charged repeatedly, i.e., secondary batteries, or not recharged, i.e., primary batteries. The essential components of primary or secondary batteries include the positive and negative electrode, a separating medium and an electrolyte. In general, chemically active materials at the negative electrode are oxidized to release electrons that travel to the positive electrode, creating useable current, where they reduce chemically active materials at the positive electrode. Capacitors have the same basic design as batteries, except that the charge storage is capacitive rather than Faradaic. In general, capacitors have low energy density but high power, as opposed to batteries which have traditionally been high energy density but low power. The distinction between batteries and capacitors is becoming more vague as higher energy capacitor materials and high power density battery components are being sought.

Fuel cells rely on a basic oxidation-reduction reaction of a fuel and an oxidant, where the reaction takes place on electrodes which include a catalyst, for example platinum. The reaction includes a transfer of electrons to the oxidant, such as pure O₂ or atmospheric oxygen, through the positive electrode material, while electrons transfered to the reductant, such as H₂, go through the negative electrode material. Typically, the electrode materials in a fuel cell are porous plates or nets made of carbon, metals e.g., nickel, metal oxides, or metal alloys.

Presently, most electric energy-generating or -storing devices rely upon chemically active materials that contain metal oxide compounds, due to their excellent oxidizing and reducing capabilities. The metal oxide compounds typically contain manganese, cobalt, nickel, lead, cadmium, silver, and the like. Unfortunately, the use of metal oxides represents a large scale environmental problem, where production and disposal of the materials may result in the release of heavy metals into the environment. Further, these heavy metals are often rare and therefore expensive.

Recently, conducting organic polymers have been substituted for metal oxides in rechargeable batteries (Novák et al., 1997, Chem. Rev. 97:207-281). These polymers have also been studied as materials for capacitors. Exemplary polymers which have shown promise in these areas include, poly(aceylene), poly(phenylene), poly(aniline), poly(pyrrole), poly(thiophene), and poly(acene) (Scrosati et al., 1984, J. of Electrochem. Soc. 131(12):2761-2767; Shacklette et al., 1985, J. of Electrochem. Soc. 132(7) 1529-1535; Echigo et al., 1993, Synthetic Metals 55-57:3611-3616; Lee et al., 1991, J. of Applied Electrochem. 22:738-742; Panero et al., 1986, Electrochimica Acta, 31(12):1597-1600; Yata et al., 1990, Synthetic Metals, 38:177-184). Typically, conducting organic polymers are charged and discharged by the doping and de-doping of the polymer, where the maximum doping and de-doping capacity found in the art is between 50-60% (Denchi Binran (Handbook of Batteries)/Supplemental Edition, ed by Y. Matsuda & Z. Takehara, Maruzen (Tokyo, 1995), p. 341, Table 3-7-16). Unfortunately, due to the low percentages of doping/de-doping of the organic polymers, they have shown low capacity. Other troublesome issues have been discovered using organic polymers, including low charge and discharge rates, low electric power, short life cycles, low stability, and short shelf lives.

Conducting organic sulfur polymers, for example poly(disulfide) and poly(carbondisulfide), have also been studied as the active materials in batteries (Oyama et al., 1995, Nature 373:598-600). Here, the electricity is generated by oxidation and reduction of the sulfur atoms in the polymer, but as above, these polymers have shown low charge and discharge rates and electrode efficiency. Even when other organic conductive polymers were added to the electrode, for example poly(aniline), the results remained the same. Finally, recent attempts to use poly(indole) and poly(quinoxalinephenylene) in these applications have failed to improve on polymer based electrode capacity (67th Meeting of the Electrochemical Society of Japan, Abstract, SIG23, p147 (2000 Nagoya).

Accordingly, there is a need to develop electrode materials using polymer material, that maintain high capacity, high charge and discharge rates, high power, higher stability and hence higher shelf lives, than the present generation of polymer materials. Against this backdrop the present invention has been developed.

### SUMMARY OF THE INVENTION

Embodiments of the present invention are directed to the novel uses of doped and un-doped polymers having at least one unit containing at least one cyclopentanone structure condensed with at least two aromatic rings as materials in the positive and/or negative electrodes of electric energy-generating or -storing devices, such as batteries, capacitors and fuel cells. Preferred polymers for use with the invention include, but are not limited to, poly(9-fluorenone), poly(cyclopenta[def]fluorene-4,8-dione), poly(benzo [b]fluoren-11-one), poly(dibenzo[b,h]fluoren-12-one), poly(cyclopenta[def]phenanthren-4-one), poly(8H-cyclopenta[def]fluoren-4-one), and poly(indeno[1,2-b]fluorene-6,12-dione) (see FIGS. 1a and 1b).

Doping of the polymers of the present invention with anions forms more active materials for a positive electrode, while doping of the polymers of the present invention with cations forms more active materials for a negative electrode.

These and various other features as well as advantages which characterize the present invention will be apparent from a reading of the following detailed description and a review of the associated drawings.

### BRIEF DESCRIPTION OF THE DRAWINGS

FIGS. 1a and 1b illustrates exemplary carbonyl aromatic polymer units in accordance with the present invention.

FIG. 2 illustrates the excited structure of carbonyl groups in the ground state.

FIG. 3 shows one manner by which poly(9-fluorenone) (FIG. 3a) and poly(cyclopenta[def]fluorene-4,8-dione) (FIG. 3b) can be doped with a cation.

FIG. 4 shows one manner by which poly(9-fluorenone) (FIG. 4a) and poly(cyclopenta[def]fluorene-4,8-dione) (FIG. 4b) can be doped with an anion.

FIG. 5 is a partial cross-sectional view of a battery utilizing a polymer as the active materials in the positive and/or negative electrodes in accordance with one embodiment of the present invention.

FIG. 6 shows one example, poly(9-fluorenone), of a carbonyl aromatic polymer of the present invention acting as a proton (H⁺) mediator when used as a material in an electrode in a fuel cell.

FIG. 7 shows one example, poly(9-fluorenone), of a carbonyl aromatic polymer of the present invention acting as a hydroxide anion (OH⁻) mediator when used as a material in an electrode in a fuel cell.

### DETAILED DESCRIPTION

The following definitions are provided to facilitate understanding of certain terms used frequently herein and are not meant to limit the scope of the present disclosure.

Definitions:

“Alkoxy group of C₁ to C₁₀” when used in the context of the present invention are exemplified by methoxy, ethoxy, propoxy, isopropoxy, butoxy, isobutoxy, tert-butoxy, pentoxy, hexyloxy, heptyloxy, octyloxy, nonyloxy, and decyloxy.

“Alkoxycarbonyl group of C₂ to C₁₀” when used in the context of the present invention are exemplified by methoxycarbonyl, ethoxycarbonyl, propoxycarbonyl, butoxycarbonyl, pentoxycarbonyl, hexyloxycarbonyl, heptyloxycarbonyl, octyloxycarbonyl, nonyloxycarbonyl, and decyloxycarbonyl.

“Alkyl group of C₁ to C₁₀” when used in the context of the present invention are exemplified by methyl, ethyl, propyl, isopropryl, butyl, isobutyl, tert-butyl, penty, hexyl, heptyl, octyl, nonyl, and decyl.

“Aryl group of C₆ to C₁₀” when used in the context of the present invention are exemplified by phenyl, tolyl, xylyl, fluorophenyl, chlorophenyl, bromophenyl, iodophenyl, difluorophenyl, trifluorophenyl, pentafluorophenyl, (trifluoromethyl)phenyl, bis(trifluoromethyl)phenyl, cyanophenyl, and naphthyl.

“Aryloxy group of C₆ to C₁₀” when used in the context of the present invention are exemplified by phenoxy, tolyloxy, and naphthoxy.

“Aryloxycarbonyl group of C₇ to C₁₁” when used in the context of the present invention are exemplified by phenoxycarbonyl, tolyloxycarbonyl, and naphthoxycarbonyl.

“Carbonyl Aromatic Polymer” refers to polymers containing one or more units that contains at least one cyclopentanone structure condensed with at least two aromatic ring structures. One preferred embodiment of a unit of a carbonyl aromatic polymer has the general formula (I):

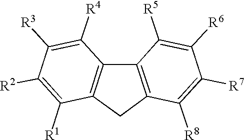

wherein any of the adjacent groups R¹ and R², R² and R³, R³ and R⁴, R⁵ and R⁶, R⁶ and R⁷, R⁷ and R⁸ may be bonded together by a group of the general formula —CR⁹═CR¹⁰—CR¹¹═CR¹²—, or be a group with the general formula (II):

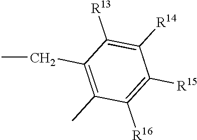

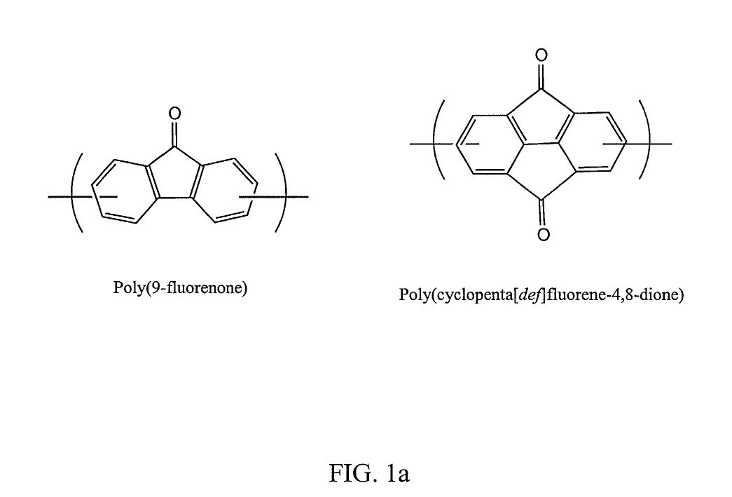

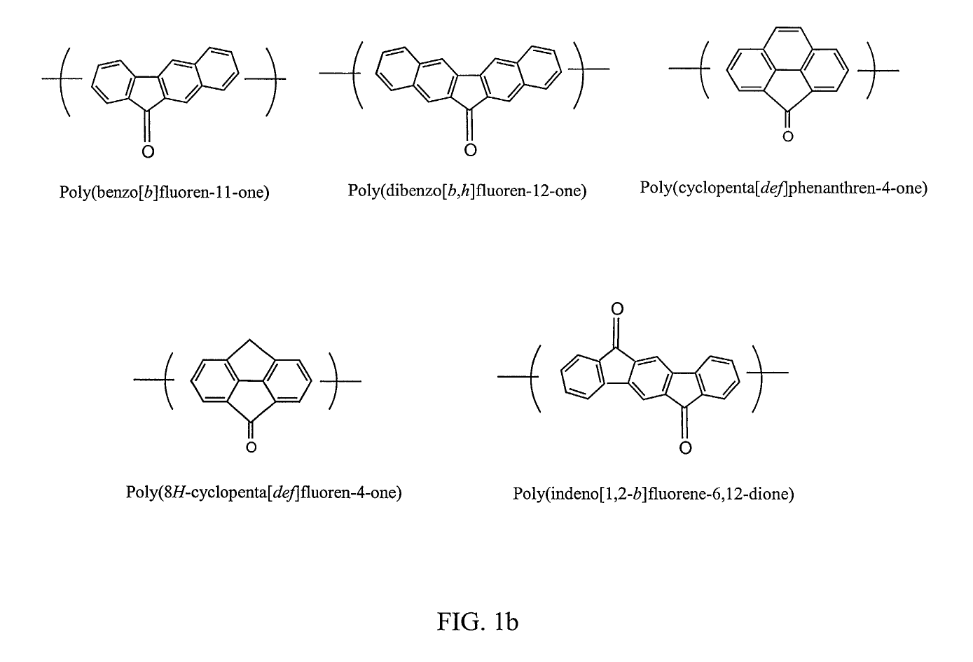

thus forming additional ring structures. Furthermore, the adjacent group R⁴ and R⁵ may be bonded together by a group with the general formula —CR¹⁷═CR¹⁸— or —CH₂—. Simultaneously, at least two of the groups R¹, R², R³, R⁴, R⁵, R⁶, R⁷, R⁸, R⁹, R¹⁰, R¹¹, R¹², R¹³, R¹⁴, R¹⁵, R¹⁶, R¹⁷ and R¹⁸ are single bonds. The remaining groups can be any combination of hydrogen atoms, halogen atoms, alkyl groups of C₁ to C₁₀, haloalkyl group of C₁ to C₁₀, aryl groups of C₆ to C₁₀, alkoxy groups of C₁ to C₁₀, aryloxy groups of C₆ to C₁₀, alkoxycarbonyl groups of C₂ to C₁₀, and aryloxycarbonyl groups of C₇ to C₁₁. Example carbonyl aromatic polymers for use in the present invention include, but are not limited to, poly(9-fluorenone), poly(benzo[b]fluoren-11-one), poly(dibenzo[b,h]fluoren-12-one), poly(cyclppenta[def]phenanthren-4-one), poly(8H-cyclopenta[def]fluoren-4-one), poly(cyclopenta[def]fluorene-4,8-dione), and poly(indeno[1,2-b]fluorene-6,12-dione) (see FIGS. 1a and 1b).

“Doping” refers to the addition of impurities to a polymer to achieve a desired electrical characteristic. Impurities for purposes of the present invention can be used to produce anion-doped or cation-doped polymers, and include, but are not limited to, BF₄⁻, PF₆⁻, Li⁺, Ca²⁺, and the like (see below). Doping is measured as a percentage of the available doping sites. Thus 100% doped means that every available doping site is bonded or associated with the appropriately charged anion or cation. For example, 100% cation-doped poly(9-fluorenone) means that every appropriately charged carbonyl group is bonded or associated with a cation. Doping for purposes of the present invention is typically 1% or greater, preferably 10% or greater, more preferably 50% or greater, even more preferably 75% or greater, and most preferably 90% or greater.

“Electric energy-generating” or “electric energy-storing” devices refer to any device that utilizes a chemical or physical change to cause or be associated with an electrical phenomena. Exemplary electric energy-generating or electric energy-storing devices include, but are not limited to, batteries, capacitors, and fuel cells.

“Electrode” in principle, refers to either of two different substances having a different electromotive activity that enables an electric current to flow in the presence of an electrolyte. Note that there are cases wherein positive and negative electrodes are discharged to form the same substances at both electrodes. Electrodes are essential components of the electric energy-generating or electric energy-storing device such as batteries, capacitors, and fuel cells. A positive electrode is the electrode where electrons are taken up by the positive electrode active material being reduced. A negative electrode is the electrode where electrons are given up by the negative electrode material being oxidized.

“Haloalkyl group of C₁ to C₁₀” when used in the context of the present invention are exemplified by fluoromethyl, chloromethyl, bromomethyl, iodomethyl, difluoromethyl, dichloromethyl, trifluoromethyl, trichloromethyl, trifluoroethyl, perfluoroethyl, trifluoropropyl, perfluoropropyl, perfluorobutyl, perfluoropentyl, perfluorohexyl, perfluoroheptyl, perfluorooctyl, perfluorononyl, and perfluorodecyl.

“Halogen atom” or “halogen” when used in the context of the present invention is exemplified by fluorine, chlorine, bromine, and iodine atoms.

“Poly(9-fluorenone)” refers to any polymer that has at least one 9-fluorenone unit, preferred poly(9-fluorenone) refers to a polymer having at least 20% W/W 9-fluorenone units, more preferably a polymer having at least 40% W/W 9-fluorenone units, even more preferably having at least 60% W/W 9-fluorenone units, and most preferably as least 80% W/W 9-fluorenone units. It should be understood that such polymers may certain any and all possible isomers of 9-fluorenone units within the polymer structure, including, but not limited to, the 1,5-isomer, the 1,6-isomer, the 1,7-isomer, the 1,8-isomer, the 2,5-isomer, the 2,6-isomer, the 2,7-isomer, the 2,8-isomer, the 3,5-isomer, the 3,6-isomer, the 3,7-isomer, the 3,8-isomer, the 4,5-isomer, the 4,6-isomer, the 4,7-isomer, and the 4,8-isomer. Such polymers are typically at least a total of 5 units of 9-fluorenone or of 9-fluorenone and other units in length, preferably at least 10 units in length, more preferably at least 50 units in length, even more preferably at least 165 units in length, and most preferably at least 200 units in length.

“Poly(cyclopenta[def]fluorene-4,8-dione)” refers to any polymer having at least one unit of cyclopenta[def]fluorene-4,8-dione, and preferably a polymer having at least 20% W/W cyclopenta[def]fluorene-4,8-dione units, more preferably a polymer having at least 40% W/W cyclopenta[def]fluorene-4,8-dione units, even more preferably having at least 60% W/W cyclopenta[def]fluorene-4,8-dione units, and most preferably as least 80% W/W cyclopenta[def]fluorene-4,8-dione units. It should be understood that such polymers may contain any and all possible isomers of cyclopenta[def]fluorene-4,8-dione units within the polymer structure. Such polymers are typically at least a total of 5 units in length of cyclopenta[def]fluorene-4,8-dione or of cyclopenta[def]fluorene-4,8-dione and other units, preferably at least 10 units in length, more preferably at least 50 units in length, even more preferably at least 165 units in length, and most preferably at least 200 units in length.

“Units” when used in the context of a polymer refers to any isomer of a monomer contained in the polymer, such that a polymer having a unit of fluorenone is a polymer that has one fluorenone structure of any isomer within the polymer chain.

Electrode Material

An embodiment of the present invention includes electrode materials containing polymers having at least one unit containing at least one cyclopentanone structure condensed with at least two aromatic rings, referred to for the remainder of this patent as “carbonyl aromatic polymers”. Preferred examples of polymers of the present invention include, but are not limited to, poly(9-fluorenone), poly(cyclopenta[def]fluorene-4,8-dione), and the like, as shown in FIGS. 1a and 1b. Note that the polymers of the present invention can be prepared using the methods described in the co-pending application entitled “Method For Preparing Polymers Containing Cyclopentanone Structures” or with other conventionally known methods within the art.

Carbonyl aromatic polymers make excellent active materials for both positive and negative electrodes for batteries, or capacitors, due to the electromotive force derived from the carbonyl groups in the polymers.

Carbonyl aromatic polymers make excellent electrode materials for fuel cells, due to the chemical nature of the carbonyl groups in the polymers, which can act as proton or hydroxide anion mediators (as is described in greater detail below).

The electromotive force (ΔV) corresponds to the energy difference (ΔG) between the formation energy of positive electrode material and the formation energy of negative electrode material, as shown in the well-known free energy equation:

−FΔV=ΔG

wherein F is the Faraday constant and n is the number of electrons involved in the stoichiometric reaction. As the equation shows, the higher the formation of energy of the active material at the positive electrode, relative to the negative electrode material, the higher the electromotive force. Conversely, the lower the formation energy of the active material at the negative electrode, relative to the positive electrode material, the higher the electromotive force.

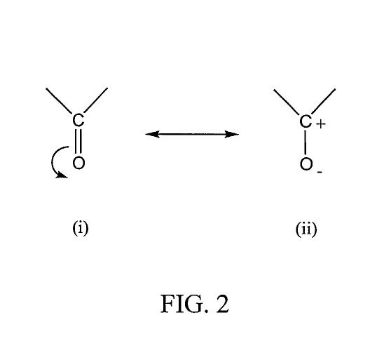

As illustrated in FIG. 2, the carbonyl groups in the polymers of the present invention have an excited structure (shown as formula ii) in the ground state, and thus have a strong electron-withdrawing effect. Because of this electron-withdrawing effect, the polymers of the present invention are electron deficient, and relatively less likely to release an electron (but more likely to accept an electron) than polymers that do not contain carbonyl groups, such as polyphenylene.

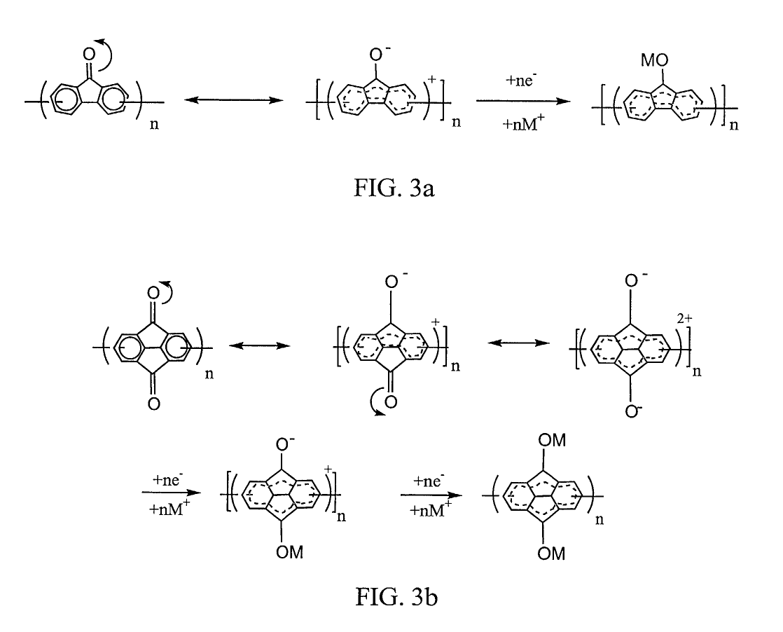

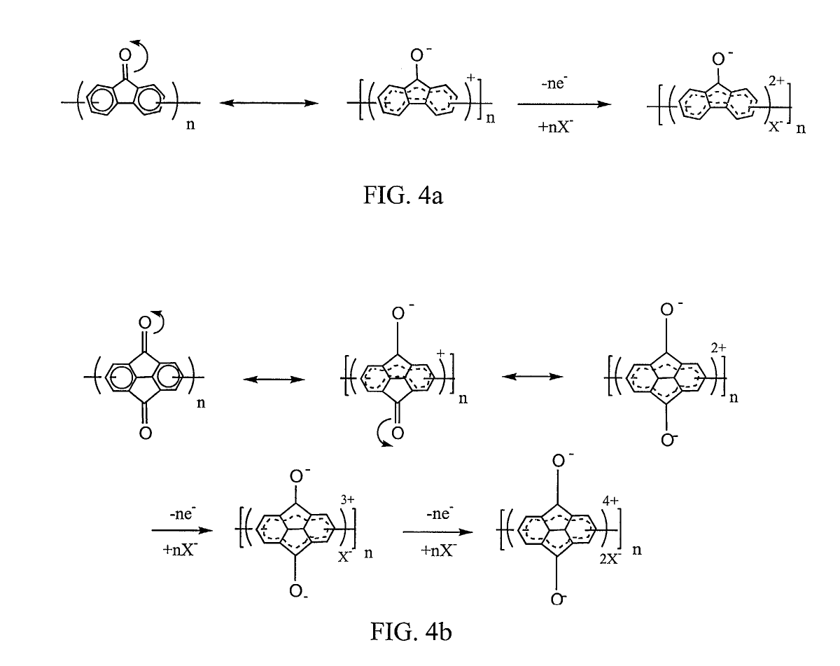

Doping of the polymers of the present invention with anions forms more active materials for a positive electrode. These anion-doped carbonyl aromatic polymers have a higher formation energy than similarly doped non-carbonyl containing polymers, for example polyphenylene. Doping of the polymer of the present invention with cations forms active materials for a negative electrode. These cation-doped carbonyl aromatic polymers have lower formation energy than similarly doped non-carbonyl containing polymers, for example polyphenylene. Thus, an open circuit voltage (which is a result of the electromotive force) in a battery using anion-doped carbonyl aromatic polymers of the present invention as the active material at the positive electrode and cation-doped carbonyl aromatic polymers of the present invention as the active material at the negative electrode which will be higher than that of a battery using un-doped electrodes. Note also that the carbonyl groups in the polymers of the present invention act as stable counter anion sites for cations doped into the polymer. FIG. 3 shows one manner by which poly(9-fluorenone) (FIG. 3a) and poly(cyclopenta[def]fluorene-4,8-dione) (FIG. 3b) can be doped with a cation (M⁺). FIG. 4 shows one manner by which poly(9-fluorenone) (FIG. 4a) and poly(cyclopenta[def]fluorene-4,8-dione) (FIG. 4b) can be doped with an anion (X⁻). Both Figures are illustrative of the overall mechanism by which carbonyl aromatic polymers of the present invention are doped by either cations or anions dependent on their anticipated use at a positive or negative electrode. Note also that each unit of cyclopenta[def]fluorene-4,8-dione in the poly(cyclopenta[def]fluorene-4,8-dione) and each unit of indeno[1,2-b]fluorene-6,12-dione in the poly(indeno[1,2-b]fluorenone-6,12-dione) have two carbonyl groups, providing a highly symmetrical structure for smooth doping and de-doping of the resultant polymers.

As discussed above, the stable counter anion site of the carbonyl aromatic polymers of the present invention have a relatively high electric storage capacity. Although, it is anticipated that doping levels of close to 100% may be achievable, in embodiments of the present invention doping is typically 1% or greater and levels of greater than 50% are believed achievable.

The electric capacity for the carbonyl aromatic polymers of the present invention should be at least 15 mAh/g, is preferably 30 mAh/g, is more preferably 75 mAh/g, and is most preferably 135 mAh/g or greater. Note that the un-doped polymers of the present invention can also act as the positive or negative electrode as long as the opposite electrode has an appropriate reduction or oxidation potential.

Embodiments of the present invention include electric energy-generating or -storing devices which incorporate the carbonyl aromatic polymers of the present invention. For example, in one embodiment, anion doped or un-doped carbonyl aromatic polymers of the invention, e.g., poly(9-fluorenone), can be used as the positive electrode active material and cation doped or un-doped carbonyl aromatic polymers of the invention, e.g., poly(9-fluorenone), can be used as the negative electrode active material. This type of device will hereinafter be referred to as Type I devices.

In another embodiment of the present invention, anion doped or un-doped carbonyl aromatic polymers of the invention, e.g., poly(9-fluorenone), can be used as the positive electrode active material and known conventional negative electrode materials are used at the negative electrode. These types of devices will hereinafter be referred to as Type II devices.

In another embodiment of the present invention, known conventional positive electrode materials are used at the positive electrode and cation doped or un-doped carbonyl aromatic polymers of the invention, e.g., poly(9-fluorenone), can be used as the negative electrode active material. These types of devices will hereinafter be referred to as Type III devices.

Type I: Positive electrode; the anion-doped or undoped polymers of the present invention. Negative electrode; the cation-doped or undoped polymers of the present invention.

Type 2: Positive electrode; the anion-doped or undoped polymers of the present invention. Negative electrode; the known materials.

Type 3: Positive electrode; the known materials. Negative electrode; the cation-doped or undoped polymers of the present invention.

The following Type I, II and III devices can be used in a battery, or other electric energy-generating or -storing devices, for example fuel cells and capacitors, all of which are within in the scope of the present invention. Note, that in the case of a fuel cell, the positive electrode is designed so that oxygen or air flows through the electrode, and the negative electrode is designed so that fuel flows through the electrode (see below).

With regard to Type I devices, there are four possible doping combinations for use with the present invention, including: anion doped carbonyl aromatic polymers at the positive electrode and cation doped carbonyl aromatic polymers at the negative electrode; anion doped carbonyl aromatic polymers at the positive electrode and un-doped carbonyl aromatic polymers at the negative electrode; un-doped carbonyl aromatic polymers at the positive electrode and cation (doped carbonyl aromatic polymers at the negative electrode; and un-doped carbonyl aromatic polymers at both electrodes. In each case, there must be a difference in the electromotive force between the polymer used at the positive electrode and the polymer used at the negative electrode. The difference in electromotive force is typically greatest when the carbonyl aromatic polymer at each electrode is appropriately doped, which represents the preferred situation. In cases where the difference in the electromotive force is marginal between the carbonyl aromatic polymers, it may be necessary to charge the polymers at the electrodes before use. For example, a device having un-doped carbonyl aromatic polymers at each electrode may need to be charged using an appropriate electrical energy source before use, i.e., each polymer appropriately charged or doped to establish an appropriate electromotive force between the two electrodes.

Discharge of the doped carbonyl aromatic polymers at each electrode results in carbonyl aromatic polymers losing charge and therefore losing their associated anions and cations. A cation doped carbonyl aromatic polymer at a negative electrode will become un-doped during discharge, while a anion doped carbonyl aromatic polymer at the positive electrode will also become up-doped. Note, however, as noted above, the polymers of the present invention can be re-charged or re-doped when the two electrodes have reached equilibrium.

Batteries and Capacitors

The polymers of the present invention are highly useful in both batteries and capacitors. Capacitors are basically the same as batteries in terms of general design, with the exception that the charge storage is capacitive in nature rather than Faradaic. Rudge et al., (1994) Electrochimica Acta, 39(2):273-287. Charging in a capacitor is achieved via the volume of the material, i.e., volume of the polymers of the present invention, rather than just the outer surface of the material. For ease of illustration, the discussion below is focused on batteries, but the use of the polymers of the present invention also applies to capacitors, which are within the scope of the present invention and are well known in the art.

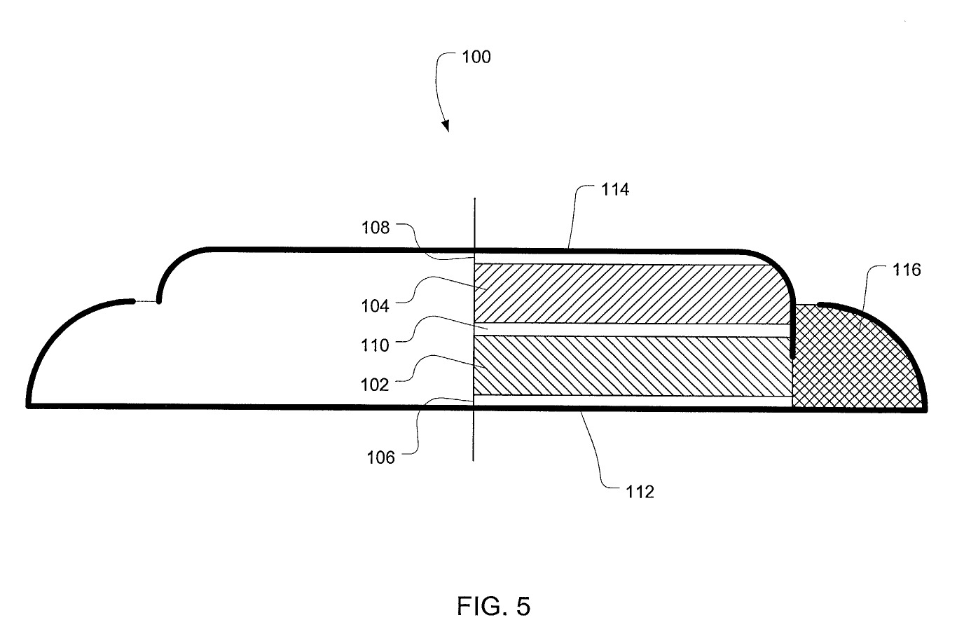

As shown in FIG. 5, a battery 100 is fundamentally composed of a positive electrode 102, a negative electrode 104, and an electrolytic solution. Where required, each of the electrodes 102 and 104 may have a current collector 106 and 108 and a separator 110 between electrodes 102 and 104. A positive electrode cap 112 and negative electrode cap 114 encase the respective electrodes and a gasket 116 seals the battery. Note that embodiments of the present invention are useful in both primary and secondary batteries, where secondary batteries are potentially more advantageous from the viewpoint of the greatest use.

As mentioned above, embodiments of the present invention include at least three types of the devices, Type I, II and III. Each type of device for a battery or capacitor is explained in more detail below, the devices in relation to fuel cells are explained in greater detail in a later section.

Type I Devices:

Embodiments of the present invention include type I devices that utilize anion-doped or undoped polymers of the invention and cation-doped or undoped polymers of the invention.

[Positive Electrode] As an active material at the positive electrode, the anion-doped or undoped polymers of the present invention can be used. The anion-doping of the polymers of the present invention can be carried out by electrochemical oxidation of the un-doped polymers of the present invention in an electrolyte solution. Alternatively, the anion-doping may be performed by charging or discharging undoped polymers of the present invention in a battery or capacitor. Preferred anions for doping the polymers of the present invention include, but are not limited to, BF₄⁻, PF₆—, PF₄(CF₃)₂⁻, PF₃(C₂F₅)₃⁻, ClO₄⁻, HSO₄⁻, SO₄²⁻, Cl⁻, F⁻, AsF₆⁻, SbF₆⁻, SbCl₆⁻, SbF₅Cl⁻, FSO₃⁻, CF₃SO₃⁻, C₂F₅SO₃⁻, C₄F₉SO₃⁻, (CF₃SO₂)₂N⁻, (C₂F₅SO₂)₂N⁻, (CF₃SO₂)₃C⁻. Note that the un-doped polymers of the present invention become doped with a cation when the battery is discharged through the electrolyte. The cation doped depends on the negative electrode material. When the negative electrode material is a cation-doped polymer of the present invention, during discharge, the cation dopes the un-doped polymer of the positive electrode, and finally, in general, the two electrodes will reach equilibrium as partially cation-doped polymers.

The un-doped and anion-doped polymers of the present invention may be finely or very finely pulverized and incorporated at the positive electrode by pressing or the like, or pressed on a current collector. In certain embodiments the doped and un-doped polymers of the present invention can be mixed with electroconductive agents, binders, electrolytes, or polar solvents. The mixture can be made into the desired form by pressing or the like, or, the mixture may be painted or pressed on a current collector. The polymer may also be mixed with other positive electrode material(s) (see below). The shape, area and thickness of the electrode may be selected according to dimensions well known in the art. Note that the polymers used at the positive electrode may be dried.

Electroconductive agents for use with the present invention include, but are not limited to, various carbonaceous materials such as activated carbons, carbon fiber, pitch, tar, carbon blacks such as acetylene black, and graphites such as natural graphite, artificial graphite, and kish graphite; metal powders such as nickel powder and platinum powder; various fine metal fibers; and as the binder, there are preferably used, for example, usual binders such as poly(tetrafluoroethylene) powder, poly(vinylidene fluoride) power, a solution of poly(vinylidene fluoride) in N,N-dimethylformamide, and carboxymethylcellulose.

The current collector for use with the present invention can be a plate, thin layer, net or the like, of various carbonaceous materials such as carbon fiber, pitch, tar, carbon blacks such as acetylene black, graphites such as natural graphite, artificial graphite, and kish graphite; a plate, a foil, a thin layer, a net, a punching metal (foamed metal), a metal fiber net or the like made of platinum, gold, nickel, stainless steel, iron, copper, aluminium or the like.

In some embodiments of the present invention, the positive electrode materials can be included with the polymers of the present invention, these include, but are not limited to, other electroconductive polymers such as anion-doped or undoped polyacetylene, polyphenylene, polyprrole, polythiophene, poly(3-phenylthiophene), poly(3-(4-fluorophenyl)thiophene), poly(3-(3,4-difluorophenyl)thiophene), poly(3-(4-cyanophenyl)thiophene, polyaniline, polyindole, and the like; metal oxides such as MnO₂, LiMn₂O₃, LiCoO₂, LiNiO₂, NiOOH, V₂O₅, Nb₂O₅, AgO, Ag₂O, RuO₂, PbO₂, and the like. The anions in the anion-doped polymers above may include, BF₄⁻, PF₆⁻, PF₄(CF₃)₂⁻, PF₃(C₂F₅)₃⁻ClO₄⁻, HSO₄⁻, SO₄²⁻, Cl⁻, F⁻, AsF₆⁻, SbF₆⁻, SbCl₆⁻, SbF₅Cl⁻, FSO₃⁻, CF₃SO₃⁻, C₂F₅SO₃⁻, C₄F₉SO₃⁻, (CF₃SO₂)₂N⁻, (C₂F₅SO₂)₂N³¹, and (CF₃SO₂)₃C⁻. The various anion-doped or un-doped carbonaceous materials mentioned above can also be used as other positive electrode materials. The anions in the anion-doped carbonaceous materials may include the same as above.

In one embodiment of the present invention the active material for the positive electrode is all or substantially all composed of the anion-doped or undoped polymers of the present intention. Other embodiments include mixtures of the above discussed ingredients with the polymers of the present invention, for example mixing 70% finely pulverized powder of a carbonyl aromatic polymer, 25% acetylene black, and 5% by wt polytetrafluoroethylene (see Example 1).

[Negative Electrode] As an active material at the positive electrode, the cation-doped or undoped polymers of the present invention can be used. The cation-doped polymers can be prepared by reduction of the undoped polymer with metals such as lithium, sodium, potassium, magnesium, and calcium or by electrochemical reduction of the undoped polymer in the electrolyte solution. The cation-doping may be made by the charging or discharging of the undoped polymer of the present invention in a battery or capacitor assembly. The cations in the cation-doped polymers include, but are not limited to, alkali metal cations such as lithium cation, sodium cation, potassium cation; alkali earth metal cations such as magnesium cation and calcium cation; tetraalkylammonium cations such as tetramethylammonium cation tetraethylammonium cation, tetrapropylammonium cation, tetrabutylammonium cation; tetraalkylphosphonium cations such as tatramethylphosphonium cation, and tetraethylphosphonium cation; 1,3-dialkyl-1H-imidazolium cations such as 1-ethyl-3-methyl-1H-imidazolium cation, and 1-butyl-3-methyl-1H-imidazolium cation. Note that when the un-doped polymer of the present invention is used, it is doped with an anion when the battery is discharged. When the anion-doped polymers of the present invention is used as a positive electrode, during discharge the un-doped polymer of the negative electrode becomes doped with the anion, and finally, in general, the two electrodes reach equilibrium as partially anion-doped polymers.

The undoped polymer or the cation-doped polymer of the present invention may be finely or very finely pulverized and made into a desired form by pressing or the like, or pressed on a current collector. In some embodiments, the polymer is mixed with an electroconductive agent, a binder, an electrolyte, or a polar solvent, and then this mixture is made into the desired form by pressing or the like. Alternatively, the mixtures can be painted or pressed on a current collector. The polymer may also be mixed with other negative electrode material(s) (see below). The shape, area and thickness of the electrode is selected according to dimensions well known in the art. Additionally, a drying process may be added, if necessary.

Electroconductive agents for use with the present invention include, but are not limited to, various carbonaceous materials such as activated carbons, carbon fiber, pitch, tar, carbon blacks such as acetylene black, and graphites such as natural graphite, artificial graphite, and kish graphite; metal powders such as nickel powder and platinum powder; various fine metal fibers; and as the binder, there may be preferably used, for example, usual binders such as poly(tetrafluoroethylene) powder, poly(vinylidene fluoride) power, a solution of poly(vinylidene fluoride) in N,N-dimethylformamide, and carboxymethylcellulose.

The current collector for use with the negative electrode of the present invention can be a plate, thin layer, net, or the like, of various carbonaceous materials such as carbon fiber, pitch, tar, carbon blacks such as acetylene black, graphites such as natural graphite, artificial graphite, and kish graphite; a plate, a foil, a thin layer, a net, a punching metal (foamed metal), a metal fiber net or the like made of platinum, gold, nickel, stainless steel, iron, copper, aluminium or the like.

In some embodiments of the present invention, negative electrode materials can be included with the polymers of the present invention, these include, but are not limited to, other electroconductive polymers such as cation-doped or undoped polyacetylene, polyphenylene, polyprrole, polythiophene, poly(3-phenylthiophene), poly(3-(4-fluorophenyl)thiophene), poly(3-(3,4-difluorophenyl)thiophene), poly(3-(4-cyanophenyl)thiophene, polyaniline, polyindole, and the like. As the cations in the cation-doped polymers, alkali metal cations such as lithium cation, sodium cation, potassium cation; alkali earth metal cations such as magnesium cation and calcium cation; tetraalkylammonium cations such as tetramethylammonium cation, tetraethylammonium cation, tetrapropylammonium cation, tetrabutylammonium cation, tatramethylphophonium cation, and tetraethylphosphonium cation. The various cation doped or un-doped carbonaceous materials mentioned above may be also used as other positive electrode materials. The cations in the cation doped carbonaceous materials may include the same as above.

In one embodiment of the present invention the active material for the negative electrode is all or substantially all composed of the cation-doped or undoped polymers of the present invention. Other embodiments include mixtures of the above discussed ingredients with the polymers of the present invention.

[Electrolyte Solution] Solvents for use in the electrolyte solutions of the present invention can be aprotic or protic. Preferable aprotic solvents include aprotic polar solvents such as carbonic esters such as propylene carbonate, ethylene carbonate, butylene carbonate, dimethyl carbonate, diethyl carbonate, ethyl methyl carbonate, fluoropropyrene cabonate, difluoropropyrene carbonate, trifluoropropylene carbonate, bis(2,2,2-trifluoroethyl) carbonate, methyl (2,2,2-trifluoroethyl) carbonate; nitriles such as acetonitrile, propionitrile, benzonitrile; aliphatic esters such as methyl formate, ethyl formate, methyl acetate, ethyl acetate, methyl propionate; lactores such as r-butyrolactone, r-valerolactone; ethers such as tetrahydrofuran, 2-methyltetrahydrofuran, 1,3-dioxolane, 4-methyldioxolane, diethyl ether, dimethoxyethane, dioxane; sulfoxides such as dimethylsulfoxide; sulfolanes such as sulfolane and methylsulfolane; amides such as N,N-dimethylformamide, N-methylpyrrolidinone, N-methyloxazolidine; and mixtures of the above. More preferred aprotic solvents are carbonic esters, aliphatic esters, lactones, ethers and mixtures of the above. Preferred protic solvents for use with the present invention include, but are not limited to, water; alcohols such as methanol, ethanol, propanol, isopropanol, butanol, ethylene glycol, monomethyl glycol, monoethyl glycol, glycerol; and mixtures of the above. Among them, water is most preferable.

The electrolytes in the electrolyte solution consist of a cation part and an anion part. The cation part can include proton (H⁺), alkali metal cations such as Li⁺, Na⁺, and K⁺, alkali earth metal anions such as Mg²⁺, Ca²⁺; tetraalkylammonium cations, and tetraalkylphosphonium cations, and as the anion parts, there are preferably exemplified, for example, hydroxide anion (OH⁻), O₂⁻, halides such as F³¹ , Cl⁻, Br⁻, and I⁻; halides anions of element Va (periodical table) such as PF₆⁻, PF₄(CF₃)₂⁻, PF₃(C₂F₅)₃⁻, AsF₆⁻, SbF₆⁻, SbCl₆⁻; perchlorate anions such as ClO₄⁻; organic anions such as CF₃SO₃⁻, (CF₃SO₂)₂N⁻, (C₂F₅SO₂)₂N⁻, and (CF₃SO₂)₃C⁻. As an actual electrolyte in the electrolyte solution, there may be preferably used, for example, HF, HCl, HBr, HI, H₂SO₄, LiHSO₄, Li₂SO₄, NaSO₄, K₂SO₄, MgSO₄, CaSO₄, H₃PO₄, LiH₂PO₄, Li₂HPO₄, Li₃PO₄, Na₃PO₄, K₃PO₄, LiOH, NaOH, KOH, Mg(OH)₂, MgO, Ca(OH)₂, CaO, HPF₆, LiPF₆, NaPF₆, KPF₆, LiPF₄(CF₃)₂, LiPF₃(C₂F₅)₃, LiAsF₆, LiSbF₆, HBF₄, LiBF₄, NaBF₄, KBF₄, HClO₄, LiClO₄, (CH₃)₄NOH, (CH₃)₄NPF₆, (C₂H₅)₄NPF₆, (C₂H₅)₄NOH, (C₂H₅)₄NBF₄, (C₃H₇)₄NOH, (C₃H₇)₄NPF₆, (C₄H₉)₄NPF₆, (C₄H₉)₄OH, CF₃SO₃H, CF₃SO₃Li, (CF₃SO₂)₂NH, (CF₃SO₂)₂NLi, (C₂F₅SO₂)₂NOH, (C₂F₅SO₂)₂NLi, (CF₃SO₂)₃CLi. Among them, HCl, H₂SO₄, NaOH, KOH, LiPF₆, LiBF₄, (CH₃)₄NPF₆, (C₂H₅)₄NPF₆, (C₂H₅)₄NBF₄ may be more preferably used.

As an electrolyte solution, ionic liquids can be used, for example, 1-ethyl-3-methyl-1H-imidazolium triflate, 1-ethyl-3-methyl-1H-imidazolium tetrafluoroborate, and 1-ethyl-3-methyl-1H-imidazolium bis(trifluoromethanesulfonyl)imide, and 1-butyl-3-methyl-1H-imidazolium hexafluorophosphate. In order to increase ionic conductivity, the ionic liquids may be mixed with the solvents and/or electrolytes shown above.

[Separator]

The separator for use with the present invention is preferably glass filters; woven fabrics, non-woven fabrics, polyesters, polypropylene, polyamides, and the like, all of which are well known in the art.

Type II Devices:

Embodiments of the present invention include type II devices that utilize anion-doped or undoped polymers of the invention (positive electrode) and conventional negative electrodes.

[Positive Electrode]

This is the same as the discussion above for Type 1 devices. However, note that the un-doped polymer of the present invention used is doped with a cation when the battery is discharged. The cation doped depends on the negative electrode material. When a lithium metal is used as the negative electrode, the un-doped polymer of the present invention is doped with a lithium cation during discharge of the battery.

[Negative Electrode]

Conventional negative electrodes for use with the type II devices are well known in the art and can include materials such as alkali metals such as lithium, sodium and potassium; alkali earth metals such as magnesium and calcium; transition metals such as zinc; alloys containing these metals such as lithium-aluminium; cation-doped or undoped carbonaceous materials such as graphitic carbons, non-graphitic carbons, acetylene black, activated carbons, and the like; cation-doped or undoped polymers such as polyacetylene, polyphenylene, polyprrole, polythiophene, poly(3-phenylthiophene), poly(3-(4-fluorophenyl)thiophene), poly(3-(3,4-difluorophenyl)thiophene), poly(3-(4-cyanophenyl)thiophene, polyaniline, polyindole, polyacene, and the like.

Cations in the cation-doped polymers of conventional negative electrodes include, alkali metal cations such as lithium cation; tetraalkylammonium cations such as tetramethylammonium cation, tetraethylammonium cation, tetrapropylammonium cation, and tetrabutylammonium cation; tetraalkylphosphonium cations such as tatramethylphosphonium cation and tetraethylphosphonium cation.

Note that the electrolye solution and separator are as described above in the Type I discussion.

Type III Devices:

Embodiments of the present invention include type III devices that utilize cation-doped or undoped polymers of the invention (negative electrode) and conventional positive electrodes.

[Positive Electrode]

Conventional positive electrode material for use with Type III devices include metal oxides such as MnO₂, LiMn₂O₃, LiCoO₂, LiNiO₂, NiOOH, V₂O₅, Nb₂O₅, AgO, Ag₂O, RuO₂, PbO₂, and the like; anion-doped or undoped carbonaceous materials such as graphitic carbons, non-graphitic carbons, acetylene black and the like; anion-doped or undoped polymers such as polyacetylene, polyphenylene, polyprrole, polythiophene, poly(3-phenylthiophene), poly(3-(4-fluorophenyl)thiophene), poly(3-(3,4-difluorophenyl)thiophene), poly(3-(4-cyanophenyl)thiophene), polyaniline, polyindole, polyacene, and the like. As the anions in the anion-doped carbonaceous materials or polymers, BF₄⁻, PF₆⁻, PF₄(CF₃)₂⁻, PF₃(C₂F₅)₃⁻, ClO₄⁻, HSO₄⁻, Cl⁻, F⁻, AsF₆⁻, SbF₆⁻, SbCl₆⁻, SbF₅Cl⁻, FSO₃⁻, CF₃SO₃⁻, C₂F₅SO₃⁻, C₄F₉SO₃⁻, (CF₃SO₂)₂N⁻, (C₂F₅SO₂)₂N⁻, (CF₃SO₂)₃C⁻, and the like.

The negative electrode, electrolyte solution and separator are the same as described above in the Type I devices.

Fuel Cells:

A fuel cell is fundamentally composed of an air electrode (a positive electrode), a fuel electrode (a negative electrode), and an electrolyte. Active materials in the air electrode are oxygen or air; while active materials in the fuel electrode are fuels such as hydrogen, methanol, natural gas, LPG, naphtha, kerosine, gasoline, gasses by coal gasification, hydrazine, and the like. The air electrode is designed to contact with oxygen or air, and the fuel electrode is designed to contact the fuel. Mainly, six types of fuel cells are known; Phosphoric Acid Fuel Cell (PAFC), Polymer Electrolyte Fuel Cell (PEFC), Alkaline Fuel Cell (AFC), Molten Carbonate Fuel Cell (MCFC), Solid Oxide Fuel Cell (SOFC) and Direct Methanol Fuel Cell (DMFC). Ion species moving in the electrolytes for PAFC, PEFC, AFC, MCFC, SOFC, and DMFC are H⁺, H⁺, OH⁻, CO₃²⁻, O²⁻, and H⁺ respectively.

In PAFC, PEFC, AFC, and DMFC fuel cells the air electrodes are typically composed of carbon, binder, metal, metal oxide or metal alloy, and a catalysis such as Pt, Au, Ni, and Ag, while the fuel electrodes are composed of carbon, binder, metal, metal oxide or metal alloy, and a catalysis such as Pt, Pd, and Ni. The electrolytes are composed of an electrolyte solution or polymer electrolyte. The carbons in the air and fuel electrodes act as an electric conductor.

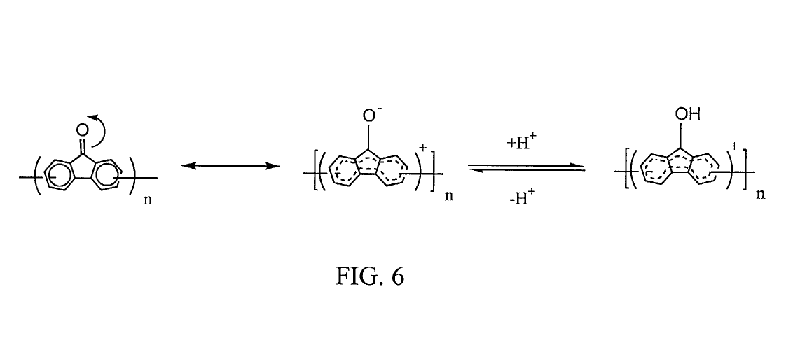

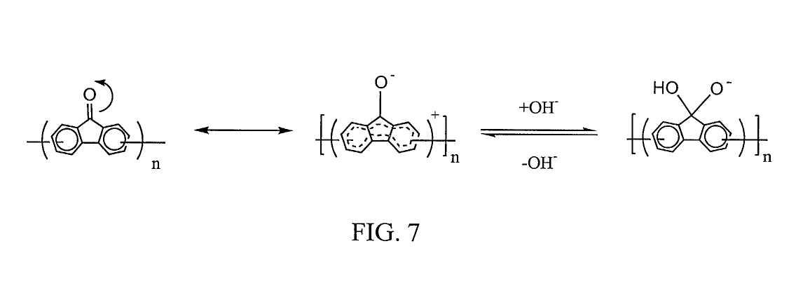

The carbonyl aromatic polymers of the present invention, for example poly(9-fluorenone), can be the electrode material or be the additive to the electrode materials for PAFC, PEFC, AFC, and DMFC, where the carbonyl aromatic polymer of the invention may be a proton (H⁺) or hydroyxide anion (OH⁻) mediator (see FIGS. 6 and 7). Polymers of the present invention may also be the electric conductors, where the fuel cells using, for example, the poly(9-fluorenone) of the present invention, afford a high efficiency for generating electricity.

The carbonyl aromatic polymers, for example poly(9-fluorenone), of the present invention may also be used as a replacement of the carbons, metals, metal oxides or metal alloys, or as an additive to the carbons, metals, metal oxides or metal alloys, which are utilized in the air and/or fuel electrodes of the conventional fuel cells.

As described above, the carbonyl aromatic polymers of the present invention are useful in PAFC, PEFC, AFC and DMFC fuel cells, and each is described below as a Type I device (although each may be used in Type II or Type III devices as well):

PAFC

[Air Electrode]

Embodiments of the present invention include the carbonyl aromatic polymers of the present invention as the air electrode. The air electrode includes a catalysis such as Pt and Pt-supported carbon. The components of the air electrode are combined to make a porous electrode of the desired shape for the fuel cell in the usual manner and technique. If necessary, the polymer may be mixed with an electroconductive agent, a binder, or, if necessary, an electrolyte.

Electroconductive agents for use with the air electrode of the present invention include, but are not limited to, various carbonaceous materials such as activated carbons, carbon fiber, pitch, tar, carbon blacks such as acetylene black, and graphites such as natural graphite, artificial graphite, and kish graphite.

Binders for use with the air electrode of the present invention include, but are not limited to, poly(tetrafluoroethylene), poly(vinylidene fluoride), a solution of poly(vinylidene fluoride) in N,N-dimethylformamide, and carboxymethylcellulose.

Electrolytes for use with the air electrode of the present invention can be phosphoric acid. Note that the shape, area and thickness of the electrode may be selected according to the purpose as is well known in the art.

[Fuel Electrode]

A fuel electrode can be made in the same manner as in the air electrode.

[Electrolyte]

Concentrated phosphoric acid is generally used as an electrolyte, and SiC and the like may be used as a supporting material for the electrolyte.

The above-mentioned elements may be assembled into the fuel cells in the usual manner and technique, which are well known in the art.

PEFC

[Air Electrode]

Embodiments of the present invention include the carbonyl aromatic polymers of the present invention as the air electrode. The air electrode includes a catalysis such as Pt and Pt-supported carbon. These components are combined to make a porous electrode of the desired shape for the fuel cells in the usual manner and technique. If necessary, the polymer may be mixed with an electroconductive agent, a binder, and if necessary, an electrolyte.

Electroconductive agents for use with the air electrode of the present invention include, but are not limited to, various carbonaceous materials such as activated carbons, carbon fiber, pitch, tar, carbon blacks such as acetylene black, and graphites such as natural graphite, artificial graphite, and kish graphite.

Binders for use with the air electrode of the present invention, include, but are riot limited to, poly(tetrafluoroethylene), poly(vinylidene fluoride), a solution of poly(vinylidene fluoride) in N,N-dimethylformamide, and carboxymethylcellulose. As an electrolyte, there can be used, for example, proton-exchange membranes or powders such as phenolsulfonic acid, poly(styrenesulfonic acid), poly(trifluorostyrenesulfonic acid), poly(perfluorocarbonsulfonic acid) (for example, NAFION®, Flemion®, Acipex®), poly(perfluorosulfonylimide), poly[(trifloromethyl)trifluorostyrene-co-trifluorostyrenesulfonic acid]. The shape, area, and thickness of the electrode may be selected according to the purpose, which are well known within the art.

[Fuel Electrode]

A fuel electrode can be made in the same manner as in [air electrode].

[Electrolyte]

The electrolyte for use with the present embodiment is, for example, a proton-exchange membrane, such as phenolsulfonic acid membrane, polystyrenesulfonic acid membrane, polytrifluorostyrenesulfonic acid membrane, perfluorocarbonsulfonic acid membrane (for example, NAFION®, Flemion®, Acipex®), perfluorosulfonylimide membrane, poly[(trifloromethyl)trifluorostyrene-co-trifluorostyrenesulfonic acid] membrane.

The above-mentioned elements may be assembled into the fuel cells in the usual manner and technique.

AFC

[Air Electrode]

Embodiments of the present invention include the carbonyl aromatic polymers of the present invention as the air electrode. The air electrode includes a catalyst such as Pt, Au, Pt—Au, Pd, Pt—Pd, Ni, and Ag. The components are combined to make a porous electrode of the desired shape for the fuel cell in the usual manner and technique. If necessary, the polymer may be mixed with an electroconductive agent, a binder, or, if necessary, an electrolyte.

Electroconductive agents for use with the air electrode of the present embodiment includes, but are not limited to, various carbonaceous materials such as activated carbons, carbon fiber, pitch, tar, carbon blacks such as acetylene black, and graphites such as natural graphite, artificial graphite, and kish graphite.

Binders for use with the air electrode embodiments of the present invention include, but are not limited to, poly(tetrafluoroethylene), poly(vinylidene fluoride), a solution of poly(vinylidene fluoride) in N,N-dimethylformamide, and carboxymethylcellulose. As an electrolyte, there can be used preferably metal hydroxides such as potassium hydroxide and sodium hydroxide or their aqueous solutions.

The shape, area, and thickness of the electrode may be selected according to the purpose as is well known in the art.

[Fuel Electrode]

A fuel electrode can be made in the same manner as in the air electrode.

[Electrolyte]

The electrolytes for use with the present embodiment includes, but are not limited to, concentrated aqueous solutions of metal hydroxides such as potassium hydroxide and sodium hydroxide. The concentration (weight %) of the metal hydroxides is more than 20%, and preferably, 30% -90%.

DMFC

[Air Electrode]

Embodiments of the present invention include the carbonyl aromatic polymers of the present invention as the air electrode. The air electrode includes a catalyst such as Pt, Pt—Au, Pt—Ru, Pt—Re. The components are combined to make a porous electrode of the desired shape for the fuel cell in the usual manner and technique. If necessary, the polymer may be mixed with an electroconductive agent, binder, or if necessary, an electrolyte.

Electroconductive agents for use with the air electrode of the present invention include, but are not limited to, various carbonaceous materials such as activated carbons, carbon fiber, pitch, tar, carbon blacks such as acetylene black, and graphites such as natural graphite, artificial graphite, and kish graphite.

Binders for use with the air electrode of the present invention include, but are not limited to, poly(tetrafluoroethylene), poly(vinylidene fluoride), a solution of poly(vinylidene fluoride) in N,N-dimethylformamide, and carboxymethylcellulose. As an electrolyte, there can be used, for example acidic electrolytes such as sulfuric acid.

[Fuel Electrode]

A fuel electrode can be made in the same manner as in the air electrode. The fuel for use in the fuel electrode is typically methanol.

[Electrolyte]

Typically, aqueous sulfuric acid or acidic solid electrolytes can be used as is well known in the art.

Types II and III devices for the fuel cell can be made in a similar manner as described above and in the section for the batteries and capacitors. The above-mentioned elements may be assembled into the fuel cells in the usual manner and technique.

Having generally described the invention, the same will be more readily understood by reference to the following examples, which are provided by way of illustration and are not intended as limiting.

### EXAMPLES

### Example 1

(Type 1)

A positive electrode may be prepared by mixing 70% by wt of a very finely pulverized powder of a polymer of the present invention, 25% by wt acetylene black, and 5% by wt polytetrafluoroethylene. These ingredients may be mixed and pressed into a thin tablet having a diameter of 14 millimeters (mm). A negative electrode may be prepared in the same manner as the positive electrode. An electrolyte solution may be 1 mol/L of LiAsF₆ in propylene carbonate and a separator may be Cellgard #2400 available from Hohsen, Inc. The components may be combined using a bottom cell as is well known in the art to produce a bottom type of electric energy-generating or -storing device. The device may be charged at a potential of 4-4.5 volts (V). As a result, the electromotive force of the device may be expected to be 3.5-4.3V, which is higher than that (3.3V) in the case of polyphenylene. The electric capacity of the polymer as the negative electrode may be expected to be 70-150 milliamp hours per gram (mAh/g), which are much higher than that (35 mAh/g) observed for cation-doping polyphenylene (Shacklette, et al., supra), and the polymer as the positive electrode may be expected to be of the same level of that (53 mAh/g) observed for anion-doping of polyphenylene (Shacklette, et al., supra).

### Example 2

(Type 2)

In this example, poly(9-fluorenone) that was prepared by the electrolysis of fluorene in the presence of an ester was used as a positive electrode. A positive electrode, a nickel plate having upon which is deposited 0.7 milligrams (mg) of poly(9-fluorenone), was prepared as follows; 0.7 mg of poly(9-fluorenone) was deposited as a thin film on one side of a nickel plate (12 mm×12 mm×0.025 mm) by the electrolysis of fluorene (0.01 mols per liter (mol/L)) in an electrolytic cell using a solution of 0.1 mol/L of LiPF₆ in propylene carbonate. The electrolysis was carried out by the potential-sweep method; sweep rate 50 millivolts per second (mV/sec), sweep width 1.0-2.7V. A negative electrode was prepared from a lithium metal having a 13 mm diameter and a 0.38 mm thickness. An electrolyte solution was 130 microliters (μL) of 1 mol/L LiPF₆ in ethylene carbonate/dimethyl carbonate (1/2). Cellgard #2400 and glass filter were used as a separator (Cellgard #2400 was purchased from Hohsen, Inc). The components were combined using a 2016 bottom cell as is well known in the art to produce a 2016 buttom type of electric energy-generating or -storing device. The open circuit voltage (electromotive force) was 3.2V. This device was discharged till 2V at the constant current of 23 microamps (μA) and the electric capacity of the poly(9-fluorenone) as the positive electrode was found to be 143 mAh/g, which was much higher than that (35 mAh/g) observed for cation-doping of polyphenylene (Shacklette, et al., supra). The capacity of 143 mAh/g corresponded to 95% doping to poly(9-fluorenone).

It will be clear that the present invention is well adapted to attain the ends and advantages mentioned as well as those inherent therein. While a presently preferred embodiment has been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

The entire disclosure and all publications cited herein are hereby incorporated by reference.

What is claimed is:

1. An electrode for an electric energy-generating or -storing device, comprising:
a carbonyl aromatic polymer having at least one unit that contains at least one cyclopentanone structure condensed with at least two aromatic rings.

2. The electrode of claim 1, wherein the carbonyl aromatic polymer is doped with an anion or cation.

3. The electrode of claim 1 further comprising a current collector.

4. The electrode of claim 1 further comprising an electroconductive agent.

5. The electrode of claim 1 further comprising a second electroconductive polymer.

6. The electrode of claim 1 further comprising a metal oxide.

7. The electrode of claim 1, wherein the carbonyl aromatic polymer comprises at least 20% by weight units having at least one cyclopentanone structure condensed with at least two aromatic rings.

8. The electrode of claim 1, wherein the electrode is a positive electrode.

9. The positive electrode of claim 8, wherein the carbonyl aromatic polymer is doped with an anion or cation.

10. The positive electrode of claim 8 further comprising a current collector.

11. The positive electrode of claim 8 further comprising an electroconductive agent.

12. The positive electrode of claim 8 further comprising a metal oxide.

13. The positive electrode of claim 8 further comprising a second electroconductive polymer.

14. The positive electrode of claim 8, wherein the carbonyl aromatic polymer comprises at least 20% by weight units of at least one cyclopentanone structure condensed with at least two aromatic rings.

15. The electrode of claim 1, wherein the electrode is a negative electrode.

16. The negative electrode of claim 15 further comprising a current collector.

17. The negative electrode of claim 15, wherein the carbonyl aromatic polymer is doped with a cation or anion.

18. The negative electrode of claim 15 further comprising an electroconductive agent.

19. The negative electrode of claim 15 further comprising a second electroconductive polymer.

20. The negative electrode of claim 15, wherein the carbonyl aromatic polymer comprises at least 20% by weight units of at least one cyclopentanone structure condensed with at least two aromatic rings.

21. The electrode of claim 1, wherein the electric energy-generating or -storing device is a battery.

22. The electrode of claim 21, wherein the battery is a secondary battery.

23. The electrode of claim 1, wherein the electric energy-generating or -storing device is a capacitor.

24. The electrode of claim 1, wherein the electric energy-generating or -storing device is a fuel cell.

25. The electrode of claim 1, wherein the carbonyl aromatic polymer is poly(9-fluorenone).

26. The electrode of claim 1, wherein the carbonyl aromatic polymer is poly(cyclopenta[def]fluorene-4,8-dione).

27. The electrode of claim 1, wherein the carbonyl aromatic polymer is poly(benzo[b]fluoren-11-one).

28. The electrode of claim 1, wherein the carbonyl aromatic polymer is poly(dibenzo[b,h]fluoren-12-one).

29. The electrode of claim 1, wherein the carbonyl aromatic polymer is poly(cyclopenta[def]phenanthren-4-one).

30. The electrode of claim 1, wherein the carbonyl aromatic polymer is poly(8H-cyclopenta[def]fluoren-4-one).

31. The electrode of claim 1, wherein the carbonyl aromatic polymer is poly(indeno[1,2-b]fluorene-6,12-dione).

32. An electric-generating or -storing device comprising:
at least one electrode, the electrode comprising a carbonyl aromatic polymer having at least one unit that contains at least one cyclopentanone structure condensed with at least two aromatic rings.

33. The electric energy-generating or -storing device of claim 32 further comprising an electroconductive agent added to the carbonyl aromatic polymer.

34. The electric energy-generating or -storing device of claim 32 further comprising a second electroconductive polymer added to the carbonyl aromatic polymer.

35. The electric energy-generating or -storing device of claim 32, further comprising a metal oxide added to the carbonyl aromatic polymer.

36. The electric energy-generating or -storing device of claim 32, wherein the carbonyl aromatic polymer comprises at least 20% by weight units of at least one cyclopentanone structure condensed with at least two aromatic rings.

37. The electric energy-generating or -storing device of claim 32, wherein the electric energy-generating or -storing device is a battery.

38. The electric energy-generating or -storing device of claim 37, wherein the battery is a secondary battery.

39. The electric energy-generating or -storing device of claim 32, wherein the electric energy-generating or -storing device is a capacitor.

40. The electric energy-generating or -storing device of claim 32, wherein the electric energy-generating or -storing device is a fuel cell.

41. The electric energy-generating or -storing device of claim 32 further comprising a second electrode comprising a carbonyl aromatic polymer having at least one unit that contains at least one cyclopentanone structure condensed with at least two aromatic rings.

42. The electric energy-generating or -storing device of claim 32, wherein the electrode further comprises a current collector.

43. The electric energy-generating or -storing device of claim 32, wherein the electrode further comprises an electroconductive agent.

44. The electric energy-generating or -storing device of claim 41, wherein at least one of the two electrodes further comprises a second electroconductive polymer.

45. The electric energy-generating or -storing device of claim 41, wherein at least one of the two electrodes further comprises a metal oxide.

46. The electric energy-generating or -storing device of claim 41, wherein the carbonyl aromatic polymer comprises at least 20% by weight units of at least one cyclopentanone structure condensed with at least two aromatic rings.

47. The electric energy-generating or -storing device of claim 41, wherein the electric energy-generating or -storing device is a battery.

48. The electric energy-generating or storing device of claim 47, wherein the battery is a secondary battery.

49. The electric energy-generating or -storing device of claim 41, wherein the electric energy-generating or -storing device is a capacitor.

50. The electric energy-generating or -storing device of claim 41, wherein the electric energy-generating or -storing device is a fuel cell.

51. A battery comprising:
a positive electrode;
a negative electrode; and
an electrolyte, wherein the positive electrode comprises a carbonyl aromatic polymer having at least one unit that contains at least one cyclopentanone structure condensed with at least two aromatic rings.

52. The battery of claim 51, wherein the battery is a secondary battery.

53. The battery of claim 51, wherein the positive electrode is doped with an anion.

54. The battery of claim 51, wherein the positive electrode is doped with a cation.

55. The battery of claim 51, wherein the positive electrode further comprises a current collector.

56. The battery of claim 51, wherein the positive electrode further comprises an electroconductive agent.

57. The battery of claim 51, wherein the positive electrode further comprises a second electroconductive polymer.

58. The battery of claim 51, wherein the positive electrode further comprises a metal oxide.

59. The battery of claim 51, wherein the carbonyl aromatic polymer comprises at least 20% by weight units of at least one cyclopentanone structure condensed with at least two aromatic rings.

60. A battery comprising:
a positive electrode;
a negative electrode; and
an electrolyte, wherein the negative electrode comprises a carbonyl aromatic polymer having at least one unit that contains at least one cyclopentanone structure condensed with at least two aromatic rings.

61. The battery of claim 60, wherein the battery is a secondary battery.

62. The battery of claim 60, wherein the negative electrode is doped with an anion.

63. The battery of claim 60, wherein the negative electrode is doped with a cation.

64. The battery of claim 60, wherein the negative electrode further comprises a current collector.

65. The battery of claim 60, wherein the negative electrode further comprises an electroconductive agent.

66. The battery of claim 60, wherein the negative electrode further comprises a second electroconductive polymer.

67. The battery of claim 60, wherein the carbonyl aromatic polymer comprises at least 20% by weight units of at least one cyclopentanone structure condensed with at least two aromatic rings.

68. A battery comprising:
a positive electrode;
a negative electrode; and
an electrolyte, wherein the positive electrode comprises a carbonyl aromatic polymer having at least one unit that contains at least one cyclopentanone structure condensed with at least two aromatic rings and the negative electrode comprises a carbonyl aromatic polymer having at least one unit that contains at least one cyclopentanone structure condensed with at least two aromatic rings.

69. The battery of claim 68, wherein the battery is a secondary battery.

70. The battery of claim 68, wherein the negative electrode is doped with an anion.

71. The battery of claim 68, wherein the negative electrode is doped with a cation.

72. The battery of claim 68, wherein the positive electrode is doped with an anion.

73. The battery of claim 68, wherein the positive electrode is doped with a cation.

74. The battery of claim 68, wherein the positive electrode is doped with an anion and the negative electrode is doped with a cation.

75. The battery of claim 68, wherein at least one of the positive or negative electrodes further comprises a current collector.

76. The battery of claim 68, wherein at least one of the positive or negative electrodes further comprises an electroconductive agent.

77. The battery of claim 68, wherein at least one of the positive or negative electrodes further comprises a second electroconductive polymer.

78. The battery of claim 68, wherein the positive electrode further comprises a metal oxide.

79. The battery of claim 68, wherein the carbonyl aromatic polymer comprises at least 20% by weight units of at least one cyclopentanone structure condensed with at least two aromatic rings.

80. A capacitor comprising:
a positive electrode;
a negative electrode; and
an electrolyte, wherein the positive electrode comprises a carbonyl aromatic polymer having at least one unit that contains at least one cyclopentanone structure condensed with at least two aromatic rings.

81. The capacitor of claim 80, wherein the positive electrode further comprises a current collector.

82. The capacitor of claim 80, wherein the positive electrode further comprises an electroconductive agent.

83. The capacitor of claim 80, wherein the positive electrode further comprises a second electroconductive polymer.

84. The capacitor of claim 80, wherein the positive electrode further comprises a metal oxide.

85. The capacitor of claim 80, wherein the carbonyl aromatic polymer comprises at least 20% by weight units of at least one cyclopentanone structure condensed with at least two aromatic rings.

86. A capacitor comprising:
a positive electrode;
a negative electrode; and
an electrolyte, wherein the negative electrode comprises a carbonyl aromatic polymer having at least one unit that contains at least one cyclopentanone structure condensed with at least two aromatic rings.

87. The capacitor of claim 86, wherein the negative electrode further comprises a current collector.

88. The capacitor of claim 86, wherein the negative electrode further comprises an electroconductive agent.

89. The capacitor of claim 86, wherein the negative electrode further comprises a second electroconductive polymer.

90. The capacitor of claim 86, wherein the carbonyl aromatic polymer comprises at least 20% by weight units of at least one cyclopentanone structure condensed with at least two aromatic rings.

91. A capacitor comprising:
a positive electrode;
a negative electrode; and
an electrolyte, wherein the positive electrode comprises a carbonyl aromatic polymer having at least one unit that contains at least one cyclopentanone structure condensed with at least two aromatic rings and the negative electrode comprises a carbonyl aromatic polymer having at least one unit that contains at least one cyclopentanone structure condensed with at least two aromatic rings.

92. The capacitor of claim 91, wherein at least one of the positive or negative electrodes further comprises a current collector.

93. The capacitor of claim 91, wherein at least one of the positive or negative electrodes further comprises an electroconductive agent.

94. The capacitor of claim 91, wherein at least one of the positive or negative electrodes further comprises a second electroconductive polymer.

95. The capacitor of claim 91, wherein the positive electrode further comprises a metal oxide.

96. The capacitor of claim 91, wherein the carbonyl aromatic polymer comprises at least 20% by weight units of at least one cyclopentanone structure condensed with at least two aromatic rings.

97. A fuel cell comprising:
an air electrode;
a fuel electrode; and
an electrolyte, wherein the air electrode comprises a carbonyl aromatic polymer having at least one unit that contains at least one cyclopentanone structure condensed with at least two aromatic rings.

98. The fuel cell of claim 97, wherein the air electrode further comprises an electroconductive agent.

99. The fuel cell of claim 97, wherein the carbonyl aromatic polymer comprises at least 20% by weight units of at least one cyclopentanone structure condensed with at least two aromatic rings.

100. A fuel cell comprising:
an air electrode;
a fuel electrode; and
an electrolyte, wherein the fuel electrode comprises a carbonyl aromatic polymer having at least one unit that contains at least one cyclopentanone structure condensed with at least two aromatic rings.

101. The fuel cell of claim 100, wherein the fuel electrode further comprises an electroconductive agent.

102. The fuel cell of claim 100, wherein the carbonyl aromatic polymer comprises at least 20% by weight units of at least one cyclopentanone structure condensed with at least two aromatic rings.

103. A fuel cell comprising:
an air electrode;
a fuel electrode; and
an electrolyte, wherein the air electrode comprises a carbonyl aromatic polymer having at least one unit that contains at least one cyclopentanone structure condensed with at least two aromatic rings and the fuel electrode comprises a carbonyl aromatic polymer having at least one unit that contains at least one cyclopentanone structure condensed with at least two aromatic rings.

104. The fuel cell of claim 103, wherein at least one of the positive or negative electrodes further comprises an electroconductive agent.

105. The fuel cell of claim 103, wherein the carbonyl aromatic polymer comprises at least 20% by weight units of at least one cyclopentanone structure condensed with at least two aromatic rings.
